(19) United States
(12) Patent Application Publication
(10) Pub. No.: US 2015/0363872 A1
(43) Pub. Date: Dec. 17, 2015

(54) VIRTUAL BUNDLES

(71) Applicant: TARGET BRANDS INC., Minneapolis, MN (US)

(72) Inventors: David WEINHOLD, Excelsior, MN (US); Sarah BRUCKER, Minneapolis, MN (US); Maya PAGE, Minneapolis, MN (US)

(21) Appl. No.: 14/305,326

(22) Filed: Jun. 16, 2014

(51) Int. Cl. G06Q 30/06; G06F 3/0484; G06F 3/0482; G06Q 30/02

(52) U.S. Cl. CPC G06Q 30/0641; G06Q 30/0222; G06Q 30/0633; G06F 3/04842; G06F 3/0482; G06Q 50/01

(57) ABSTRACT

A system, Internet website interface, and computer-implemented method of presenting products to a consumer for purchase via a graphical user interface on a display of a user device are disclosed. The computer-implemented method includes receiving a request from the user device to configure a virtual bundle and displaying a product listing on the display of the user device. The product listing includes an anchor product listing and at least one accessory product listing. The method includes displaying a promotional offering associated with the virtual bundle on the display of the user device, the promotional offering based on one of the anchor product listing and the at least one accessory product listing. The method further includes receiving a product selection from the plurality of product images and adding the received product selection to the virtual bundle. The method further includes updating a floating shopping cart based on the product selection.

### FIELD

This disclosure generally relates to the field of user interfaces on websites that offer products for purchase, such as on retailer websites. More specifically, this disclosure relates to a user interface for a website where a user can configure a grouping of products to be purchased together as a single virtual bundle.

### BACKGROUND

Online shopping is a continuously growing industry. A user engaging in online shopping can locate potential products of interest in a number of ways, including by conducting Internet searching or going directly to a website known by the user.

Improved ways to present products to a user for possible purchase on a website are desirable.

### SUMMARY

This disclosure generally relates to the field of user interfaces on websites that offer products for purchase, such as on retailer websites. More specifically, this disclosure relates to a user interface for a website where a user can configure a grouping of products to be purchased together as a single virtual bundle.

A website is described that includes a user interface for configuring a virtual bundle. The virtual bundle configuration process can be referred to as the virtual bundle shopping experience.

In one embodiment, configuring a virtual bundle includes sorting and/or filtering a product list to customize which products and/or in which order products are displayed on a user device. The virtual bundle is configurable with virtual bundle compatible products. A product that is not a virtual bundle compatible product may not be displayed as a configuration choice to the user. The website can include a floating shopping cart configured to scroll with a user interface as the user scrolls. The floating shopping cart includes a scrolling means such that the floating shopping cart scrolls with the user interface in order that the floating shopping cart remains displayed. In such embodiments, the floating shopping cart is displayed regardless of whether the user is viewing an upper portion, a middle portion, or a lower portion of the user interface.

In another embodiment, a promotion is included as part of a virtual bundle.

In still another embodiment, a customer shopping for a standalone product that is a virtual bundle compatible product can receive a recommendation to configure a virtual bundle that includes the standalone product. A customer purchasing a standalone product that is a virtual bundle compatible product can be presented with an option to configure a virtual bundle including the standalone product during a checkout process.

In one embodiment, a virtual bundle is configurable to include a single product quantity. In another embodiment, a virtual bundle is configurable to include a product quantity greater than one. In such an embodiment, a customer is provided with a single promotion. The single promotion can be determined based on, for example, maximizing savings for the user.

In another embodiment, a virtual bundle includes one or more special products.

In one embodiment, a bundling option during the checkout process permits a user to configure the bundle from a checkout user interface. In another embodiment, the user is directed to a configuration user interface.

In one embodiment, a user can enter the virtual bundling experience from an external website. The external website can be a social media website such as, but not limited to, Pinterest, Facebook, Twitter, Google+, or the like. In another embodiment, a user can enter the virtual bundling experience from the retail website itself.

A virtual bundle shopping experience can be uniquely tailored depending on a product-type.

In one embodiment, an image displayed in a virtual bundle shopping experience is dynamic and is configured based on the number and type of products in the virtual bundle.

A computer-implemented method of presenting products to a consumer for purchase via a graphical user interface (GUI) on a display of a user device of the consumer is described. The GUI includes a website that is accessible by the consumer and that is made available by one or more servers. The computer-implemented method includes receiving a request from the user device to configure a virtual bundle and displaying a product listing on the display of the user device. The product listing includes an anchor product listing and at least one accessory product listing. The method includes displaying a promotional offering associated with the virtual bundle on the display of the user device, the promotional offering based on one of the anchor product listing and the at least one accessory product listing. The method further includes receiving a product selection from a plurality of product images and adding the received product selection to the virtual bundle. The method further includes updating the floating shopping cart based on the product selection.

A system including a server in communication with a network, the server executing instructions for a graphical user interface (GUI) and for displaying the GUI on a display of a user device for grouping related products for purchase is described. The GUI includes a product grouping displayed on the display. The product grouping includes one or more products identified as eligible for being grouped with one or more other products for purchase; a base product grouping including at least one base product; and at least one accessory product grouping including at least one accessory product determined based on the base product grouping. The GUI includes a shopping cart displayed on the display. The shopping cart includes a scrolling means so that the shopping cart remains displayed on the display when a user scrolls to another portion of the GUI. At least one base product is selectable to configure in a product package and the at least one accessory product is selectable to configure in the product package.

An Internet website interface for configuring a bundle of products for purchase is described. The Internet website interface includes one or more servers connectable to the Internet configured to provide a website interface that is viewable on the Internet. The website interface displays a plurality of product images arranged in a product listing. Each product image is of a product that is a bundle compatible product. The product listing includes a primary product listing and one or more secondary product listings. The one or more secondary product listings are compatible with the primary product listing. The website interface displays a floating shopping cart. The floating shopping cart displays two or more of a cart product image, a virtual bundle price, a checkout button, and notice information. One of the primary product listing and the secondary product listing includes one of a filter button and a sort button.

### BRIEF DESCRIPTION OF THE DRAWINGS

References are made to the accompanying drawings that form a part of this disclosure, and which illustrate the embodiments in which the systems and methods described in this Specification can be practiced.

FIG. 1 illustrates a schematic diagram of a system for implementing the user interface, systems, and methods described herein.

FIGS. 2A-2B illustrate a configuration user interface of a website as described herein.

FIGS. 2C-2E illustrate another configuration user interface of a website as described herein.

FIG. 3A illustrates a checkout user interface corresponding to the configuration user interface of FIGS. 2A-2B of a website as described herein.

FIG. 3B illustrates another checkout user interface corresponding to the configuration user interface of FIGS. 2C-2E of a website described herein.

FIG. 4 illustrates a flowchart of a process for providing a virtual bundle shopping experience to a website customer.

FIGS. 5A-5B illustrate a flowchart of a process for a virtual bundle shopping experience.

FIG. 6 is a schematic diagram of an architecture for a computer device.

Like reference numbers represent like parts throughout.

### DETAILED DESCRIPTION

This disclosure generally relates to the field of user interfaces on websites that offer products for purchase, such as on retailer websites. More specifically, this disclosure relates to a user interface for a website where a user can configure a grouping of products to be purchased together as a single virtual bundle.

A website is described that presents a user interface for grouping together products as a virtual bundle for a user to purchase. The product images that are displayed are of products that can be sold as a virtual bundle. The website can be, for example, a website that is owned, operated, and/or controlled by a retail company. The products that are displayed for sale can be products that are available in a retail store or online on the same website or on a separate website.

A virtual bundle, as used herein, is a configurable grouping of two or more products for purchase together. A virtual bundle can be configured by a customer to include specific products within a group of products. A virtual bundle generally includes an anchor product paired with one or more accessory products. One particular example of a virtual bundle includes a camera (anchor product) and a camera lens (accessory product). It is to be appreciated that the number of accessory products can vary. A virtual bundle is generally represented as a single entity, though it contains a plurality of products. A virtual bundle can be shipped to a customer or can be picked up in a retail store. In some embodiments, a virtual bundle can alternatively be referred to as a product package or a bundle of products for purchase.

An anchor product, as used herein, is a product off of which a virtual bundle is built. Anchor products are generally a main product within a bundle. Examples of anchor products include, but are not limited to, a camera, a media player, or the like. An anchor product can be preselected in some virtual bundles, while in others, the anchor product can be selected by a user. In some embodiments, an anchor product can alternatively be referred to as a base product or a primary product.

An accessory product, as used herein, is a product that supplements an anchor product within a virtual bundle. Examples of accessory products include, but are not limited to, a camera case, lenses, a pair of headphones, or the like. At least one accessory product is included in a virtual bundle. In some embodiments, an accessory product can alternatively be referred to as a secondary product.

A product list, as used herein, includes a listing of one or more anchor products and/or one or more accessory products. In some embodiments, a product list can be alternatively referred to as a product grouping.

A virtual bundle compatible product, as used herein, is a product that can be included within a virtual bundle. A virtual bundle compatible product can be an anchor product or an accessory product. In some embodiments, a virtual bundle compatible product includes a product that is eligible to be grouped with other products for purchase as a virtual bundle.

A standalone product, as used herein, is a product that is not part of a virtual bundle. A standalone product can be a virtual bundle compatible product that is not being shopped within a virtual bundle. It is not required that a standalone product be a virtual bundle compatible product. In such a case, the standalone product can be shopped as a standalone product and not as part of a virtual bundle.

A special product, as used herein, is a product that is not available for purchase as a standalone product. A special product is available as part of a virtual bundle.

A button, as used herein, is not intended to require a particular type of display. For example, a button can include a clickable button, a hyperlink, or the like. A button is an area of a website that is clickable or otherwise selectable by a user in any manner in order to perform an action.

A website, as used herein, is a website system including at least one server that is connectable to the Internet and that is configured to provide a website that is viewable on the Internet. The website displays a plurality of product images that can be combined into a virtual bundle of products during purchase.

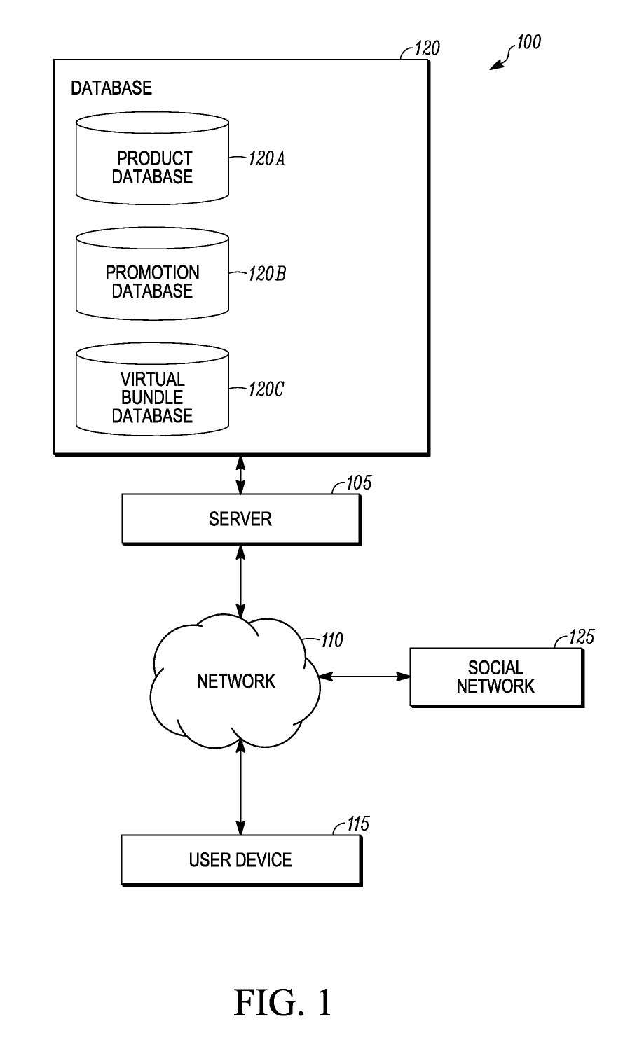

FIG. 1 illustrates a schematic diagram of a system 100 for implementing the user interface, systems, and methods described herein. In the system 100, a server 105 is connected in communication with a user device 115 via a network 110.

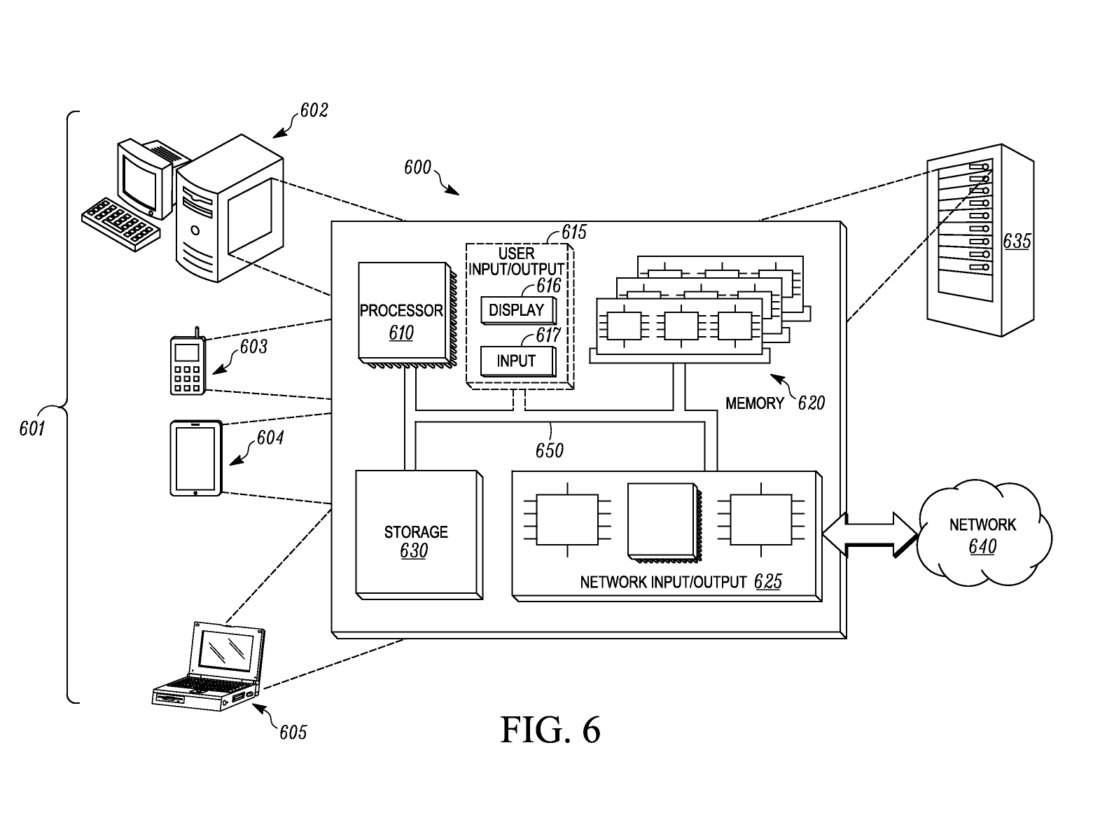

The server 105 makes a website with a graphical user interface (GUI) available to the user device 115. The server 105 makes the website available over the network 110 according to principles known in the art suitable for allowing a user to access and view the website with the user device 115. In some embodiments, aspects of the server 105 are the same as or similar to aspects of a server device 635 as described in accordance with FIG. 6 below.

The network 110 is generally representative of the Internet. The network 110 can include, for example, a local area network, a wide area network, a wireless network, a cellular data network, or the like. In some embodiments, aspects of the network 110 are the same as or similar to aspects of a network 640 as described in accordance with FIG. 6 below.

A user can create a virtual bundle by accessing the website via the network 110 and the user device 115. The user can access the website in any conventional manner including, but not limited to, using a personal computer (PC), a laptop computer, a mobile device (e.g., a smartphone, a personal digital assistant (PDA), or the like), or a tablet-style device. The GUI of the website is displayed on a display of the user device 115. Examples of the display for the user device 115 include, but are not limited to, a monitor connected to a PC, a laptop screen, a mobile device screen, a tablet screen, or the like. In some embodiments, aspects of the user device 115 are the same as or similar to aspects of the user devices 601 as described in accordance with FIG. 6 below.

The server 105 is in communication with a database 120. The database 120 generally includes a variety of information on products available through the website. A product database 120A stores information about the various products. Examples of information about the various products include, for example, details about price, options, product images, or the like. A promotion database 120B stores information about promotional options such as, but not limited to, discounts and rules for applying the promotions. A virtual bundle database 120C stores information about virtual bundling of products. The virtual bundle database 120C can, for example, store information concerning products that can be included in bundles, options relating to bundles, or the like.

The server 105 is in communication with a social network 125 via the network 110. In some embodiments, the social network 125 can display a sample virtual bundle that a user would like to purchase. Information from the social network 125 can be provided to the server 105 in order to customize a display of a virtual bundle on the user device 115. Examples of the social network 125 include, but are not limited to, Pinterest, Facebook, Instagram, Google+, Twitter, or the like.

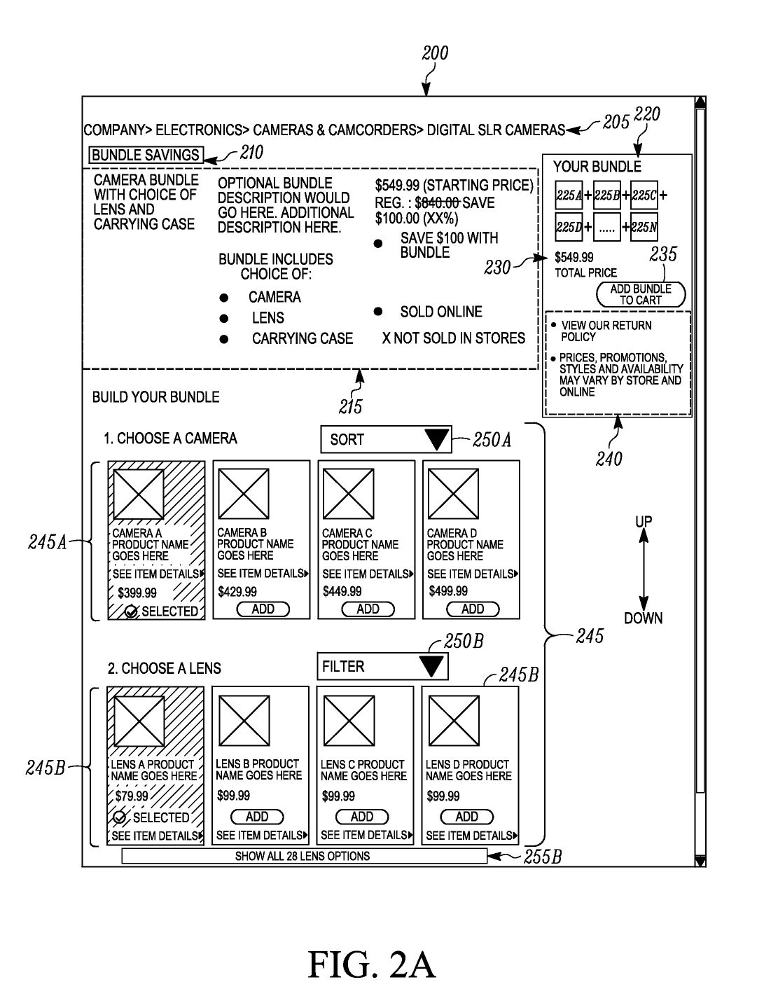

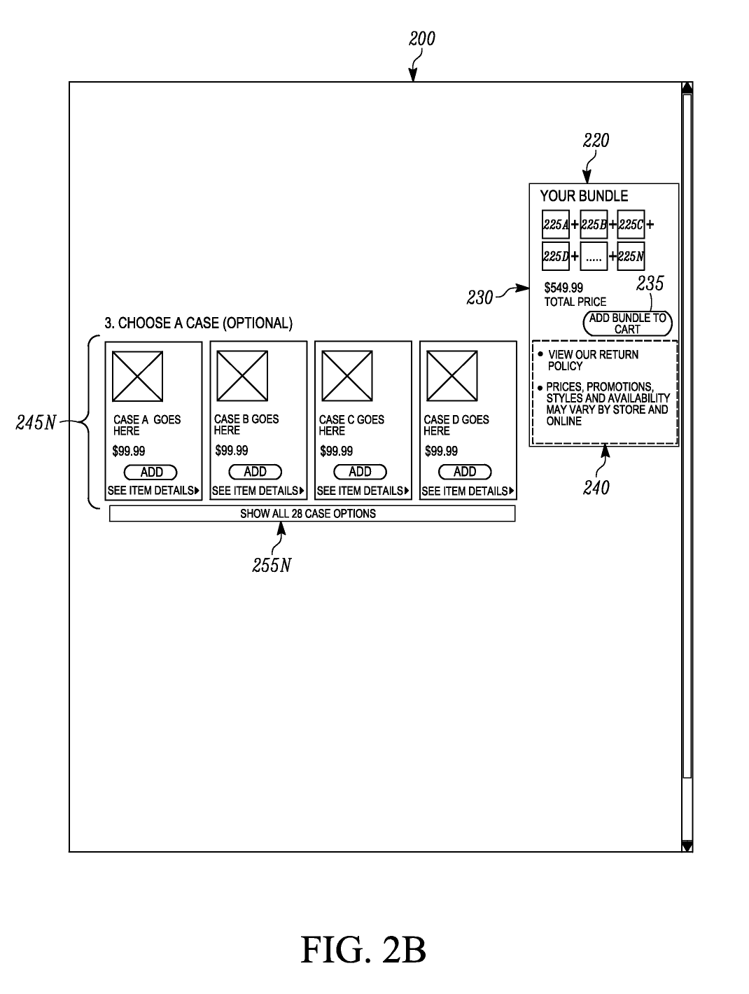

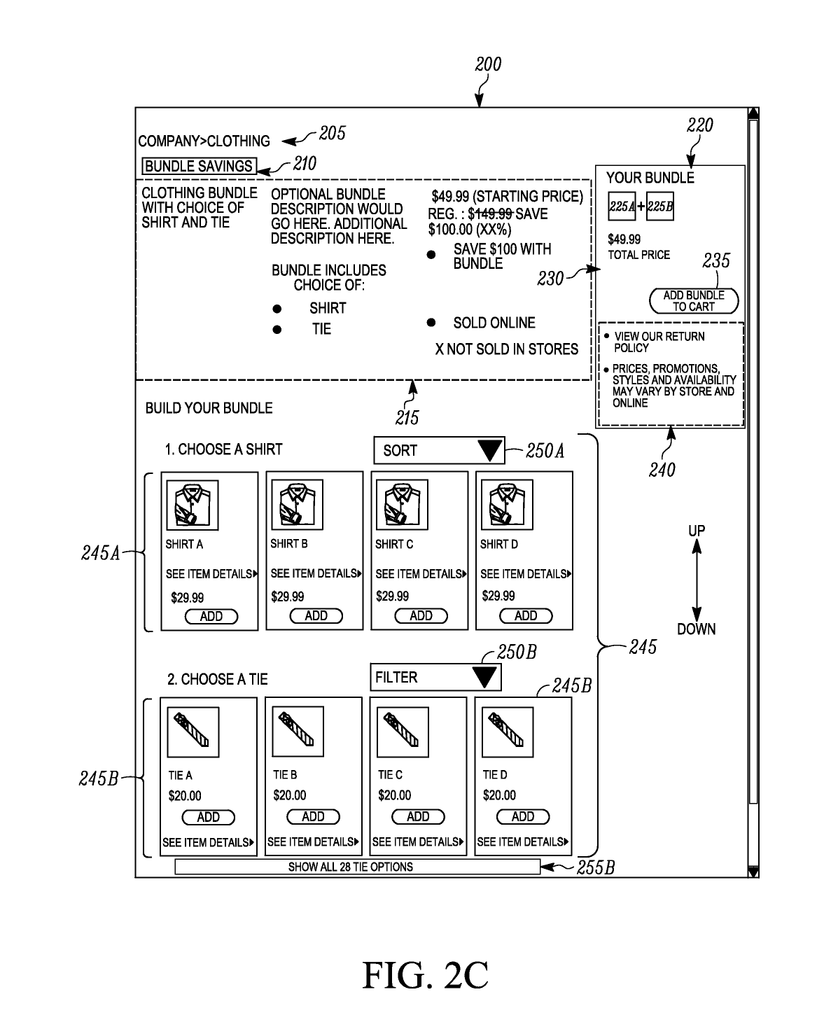

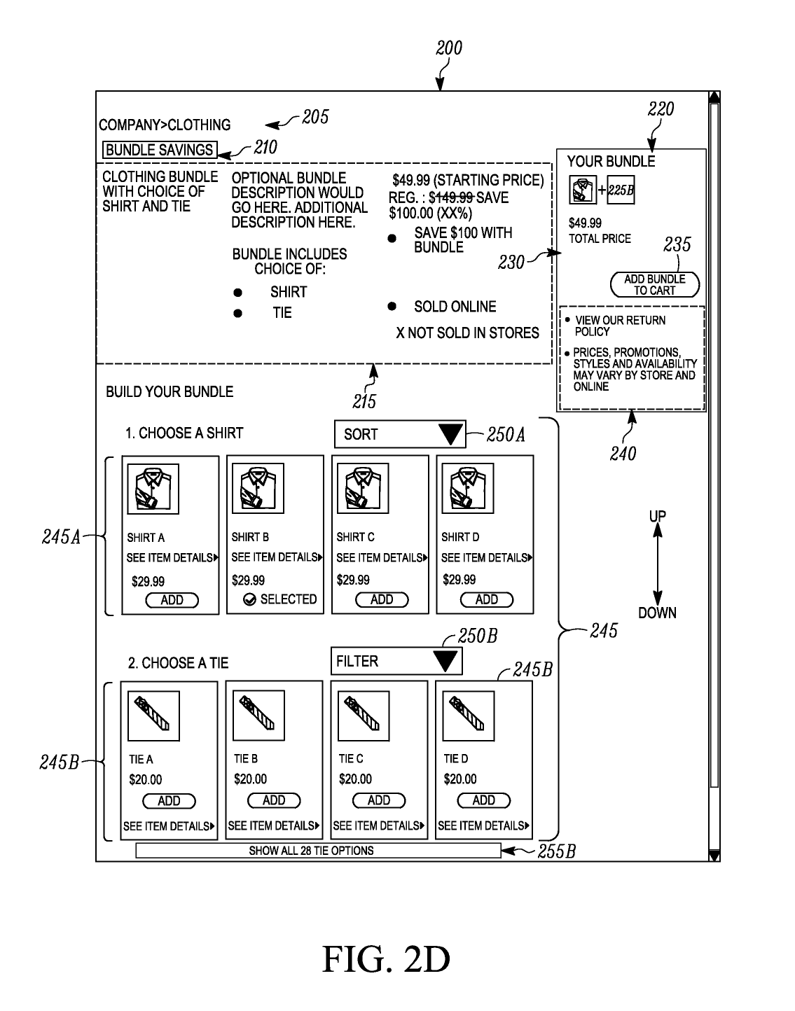

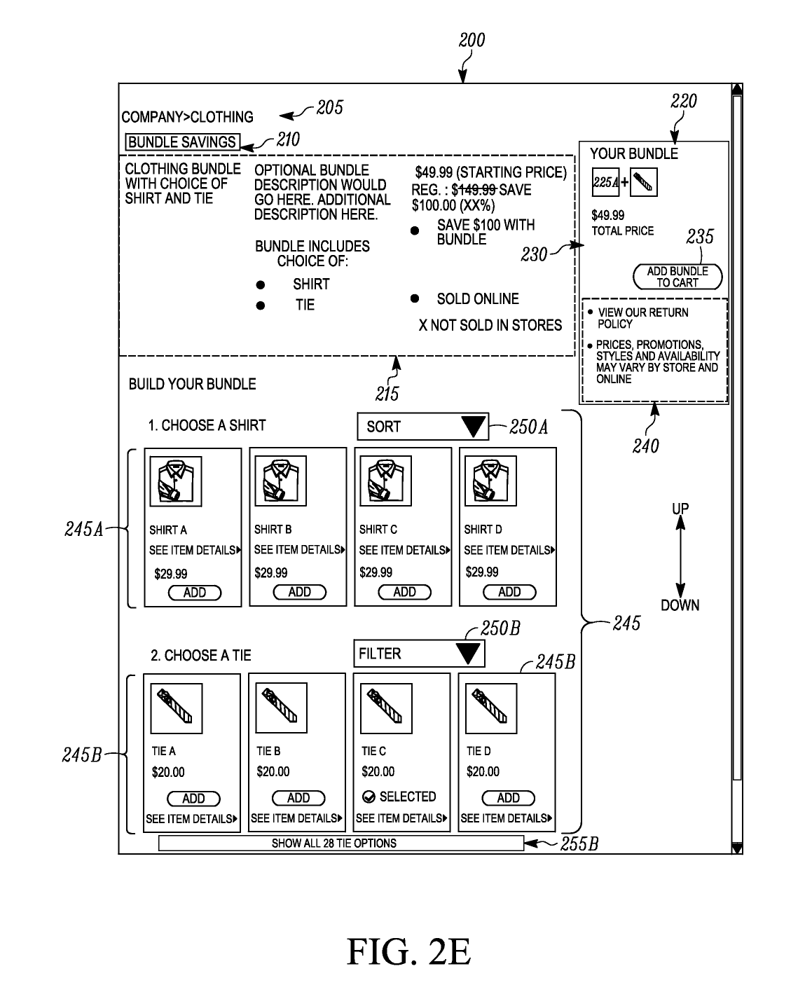

FIGS. 2A-2B illustrate a configuration user interface 200 of the website described herein for configuring a virtual bundle. FIG. 2A illustrates an upper portion of the configuration user interface 200 (e.g., a user has scrolled to a top portion) and FIG. 2B illustrates a lower portion of the configuration user interface 200. It is to be appreciated that the text and arrangement of the text are examples and can vary according to the principles described herein. The look and feel of the configuration user interface 200 can be varied depending on the category of products with a virtual bundle being configured. For example, an electronics virtual bundle can have a different configuration user interface 200 than a clothing virtual bundle.

With reference to FIG. 2A, a page breadcrumb 205 is displayed on the configuration user interface 200. The page breadcrumb 205 generally includes text which can be hyperlinked. The page breadcrumb 205 can, for example, provide a user with an indication of how she navigated to the current page view and can, for example, allow the user to click to navigate back through one or more pages of the website. The page breadcrumb 205 operates according to principles known in the art for allowing a user to keep track of her location within the website.

A virtual bundle indicator 210 shows a message such as, but not limited to, “bundle savings” to indicate to the user that she is configuring a virtual bundle, and not purchasing a standalone product.

A virtual bundle details section 215 displays information specific to the virtual bundle the user has selected to configure. Examples of information that may be displayed in the virtual bundle details section 215 include, but are not limited to, a virtual bundle name, a brief description of the virtual bundle, an indication of what can be included in the virtual bundle (e.g., categories of anchor product and accessory products), a starting price, a price when products are purchased individually (e.g., as standalone products), a promotional savings indication, or the like. The virtual bundle details section 215 can additionally include a virtual bundle image. In some embodiments, the user can click on an image from the social network 125 and be forwarded to the configuration user interface 200. In such embodiments, the virtual bundle details section 215 can include the image the user selected on the social network 125.

A floating shopping cart 220 displays contents currently included in the virtual bundle. The floating shopping cart 220 is configured to move relative to the display of the user device 115 when the user scrolls around the GUI of the website. Accordingly, even when a user has scrolled to a different location on the GUI, the floating shopping cart 220 will be displayed for the user. This can be seen by comparing FIGS. 2A and 2B, in which the floating shopping cart 220 is located in an upper portion of each figure even though a lower portion of the configuration user interface 200 is illustrated in FIG. 2B.

The floating shopping cart 220 includes a plurality of images 225A-225N. The number of images 225A-225N is dependent upon the number of products to be included in the virtual bundle. In some embodiments, the products in the virtual bundle are preselected when the GUI of the website is displayed. In such embodiments, the images 225A-225N can be replaced if the user selects a different product to be included. In other embodiments, the products in the virtual bundle are not preselected and the images 225A-225N are loaded in the floating shopping cart 220 when the user selects a product to include in the virtual bundle. The floating shopping cart 220 includes a price 230 and a button 235 for adding the virtual bundle to the user's cart. The button 235 may only be selectable once the user has configured the virtual bundle (e.g., selected the minimum number of products for the virtual bundle). Accordingly, when the virtual bundle is not configured, the button 235 can be, for example, not shown, shown but not selectable, or the like. A notice section 240 displays various links and/or information concerning the virtual bundle. In some embodiments, the notice section 240 can contain links and/or information related to specific items within the virtual bundle. In the illustrated embodiment, the notice section 240 includes a link to the retailer's return policy.

The configuration user interface 200 includes a product configuration section 245. The product configuration section 245 includes a plurality of product listing modules 245A-245N. The product-listing module 245A is representative of an anchor product listing and the product listing modules 245B-245N are representative of accessory product listings. The accessory product listings 245B-245N are selected such that they are compatible with the anchor product listing 245A. In some embodiments, compatible accessory product listings 245B-245N are those accessory products that work with the anchor product listing. For example, compatibility can be based on, but is not limited to, a category (e.g., camera anchor product and camera case accessory product), a brand of product (e.g., a specific brand of camera for an anchor product and an accessory product that is the same brand), a known compatibility (e.g., a specific brand of camera as an anchor product and an accessory product that is known to work with the brand of anchor product), or the like.

The product listing modules 245A-245N include a variety of information about each product within the list. As illustrated, in some embodiments, there may be a limit on the number of products displayed in each of the product listing modules 245A-245N. In some embodiments, a particular product (e.g., Camera A in product listing module 245A) can be identified visually as the selected product. For example, the cross-hatching may be representative of shading or another visual means of identifying the product was selected. Further, the selected product can include text and/or an additional image identifying the product as selected. In some embodiments, the products not selected (e.g., Camera B-Camera D in product listing module 245A) can include an “Add” button or similar feature such that a user can modify the product selection. If a user selects, for example, to add Camera B to the virtual bundle, the Camera A product may in turn be modified such that it includes an “Add” button or the like and Camera B is identified as the selected product. As illustrated, each product within the product listing modules 245A-245N can additionally include, for example, but not limited to, an image of the product, a product name, a hyperlink or other selectable text to display additional description about the product, a price, or the like.

The number of product listing modules 245A-245N can vary depending on a virtual bundle being configured. The product listing modules 245A-245N can include a sort option 250A and/or a filter option 250B. The sort option 250A and filter option 250B permit the user to modify which products and in which order the products are displayed in the product listing modules 245A-245N. For example, using the sort option 250A, the user can reorder the products so that they are sorted by popularity. Similarly, using the filter option 250B, the user may be able to limit what products are displayed. For example, the user may choose to only show lenses that have a minimum zoom specification. In some embodiments, using the filter option 250B can allow the user to only display products meeting a particular criterion, such as, but not limited to, price, product rating, availability, manufacturer, or the like. For example, the user may select to only show products below a specified price, above a specified price, or within a specified price range. Toggle buttons 255B-255N are selectable so that the user can display all products within a particular product-listing module 245B-245N. Some product listing modules, such as product listing module 245A, may not have a toggle button because, for example, all of the available products in the product-listing module are displayed by default.

FIGS. 2C-2E illustrate another configuration user interface 200 of a website as described herein. The configuration user interface 200 illustrated in FIGS. 2C-2E is representative of a clothing shopping experience. For simplicity of this specification, aspects of FIGS. 2C-2E previously described will not be discussed in additional detail. It is to be appreciated that the configuration user interface 200 illustrated in FIGS. 2C-2E operates similarly to the description above for FIGS. 2A-2B. The variations are provided in order to illustrate an example of a user configuring a virtual bundle for a different category of products than that described in accordance with FIGS. 2A-2B.

The virtual bundle details section 215 includes information specific to the virtual bundle the user has selected to configure. In FIGS. 2C-2E, this text indicates that the user has selected to configure a “clothing bundle” and that such a bundle gives the user a “choice of shirt and tie.” It is to be appreciated that a shirt and tie variety of clothing virtual bundle is representative and that other products can be configurable as a virtual bundle. The shirt is the anchor product in this virtual bundle and the tie is the accessory product. Accordingly, the product listing module 245A includes four different varieties of shirts from which the user can select. Similarly, the product listing module 245B includes four different varieties of ties from which the user can select.

Further, the toggle button 255B is selectable in order that the user can display 24 additional tie options. The various shirts A-D can be representative of different brands of shirts, different colors, different sizes, or the like, along with combinations thereof. Similarly, the various ties A-D can be representative of different brands of ties, different colors, different styles, or the like, along with combinations thereof.

When the user has decided upon a particular shirt, for example, Shirt B, the user can select the “Add” button within the product listing module 245A that corresponds to the Shirt B product. Upon selection, the user configuration interface 200 can be modified such that Shirt B is shown as “Selected” and an image of Shirt B from the product listing can be placed into the location 225A of the floating shopping cart 220. An example of the resulting configuration user interface 200 is illustrated in FIG. 2D. It is to be appreciated that depending on the selection of items displayed in the product listing module 245A, the user may be presented with one or more popups or other intervening screens which require the user to select, for example, but not limited to, a size, a color, or the like.

When the user has decided upon a particular tie, for example, Tie C, the user can select the “Add” button within the product listing module 245B that corresponds to the Tie C product. Similar to the process described above with respect to the shirt selection, the user configuration interface 200 can be modified such that Tie C is shown as “Selected” and an image of Tie C can be placed into the location 225B of the floating shopping cart 220. An example of the resulting configuration user interface 200 is illustrated in FIG. 2E. It is to be appreciated that the order in which the user selects the products can be varied. In such embodiments, the floating shopping cart can include an image of Tie C before an image of Shirt B is added to the floating shopping cart 220.

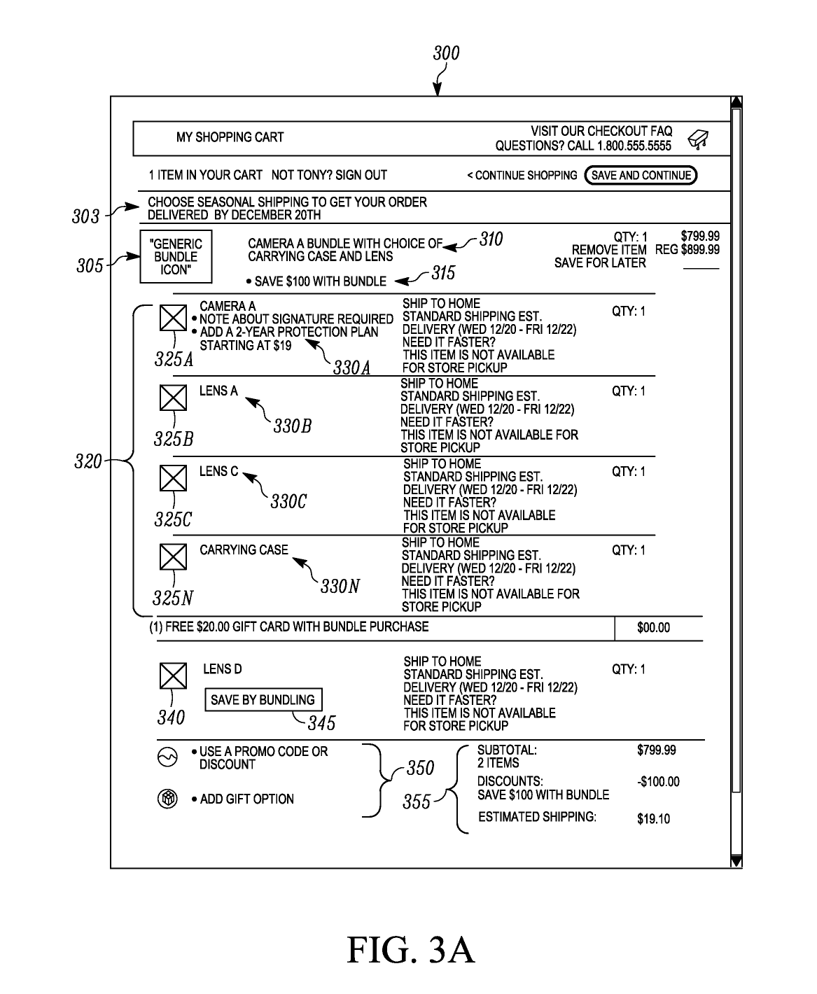

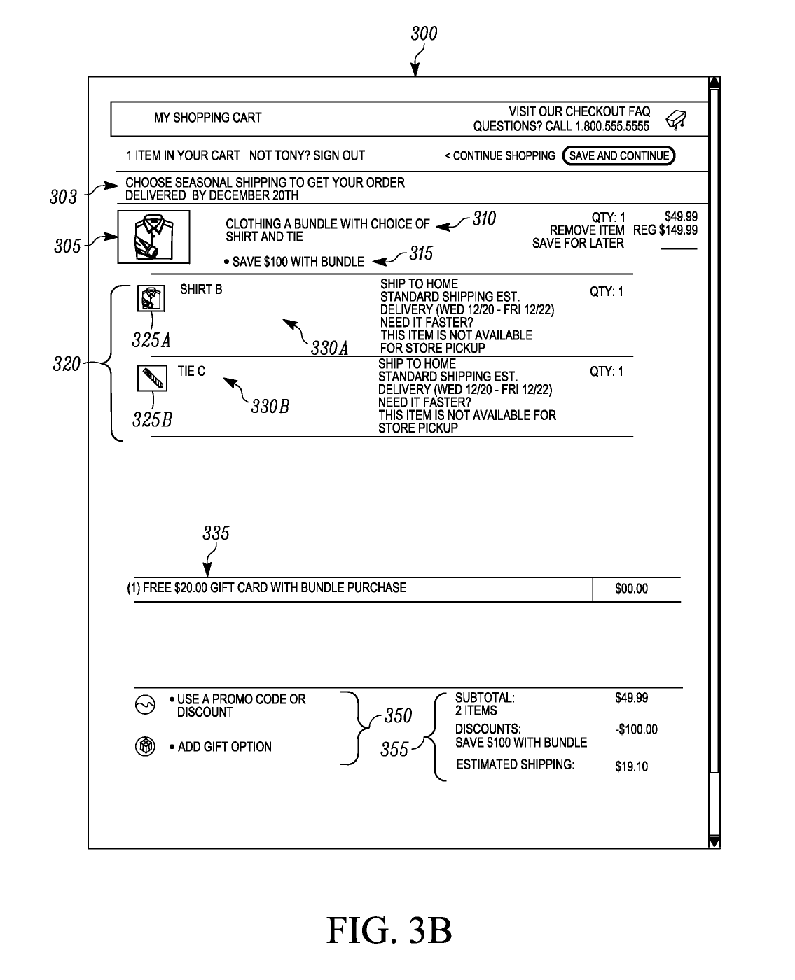

Once the user has configured the virtual bundle, the user can select the button 235 to “Add Bundle to Cart.” When the user selects to add the bundle to the cart, she may be forwarded directly to the checkout user interface 300 of FIG. 3B. In some embodiments, the user may have the option to continue shopping once the virtual bundle is in the shopping cart.

FIG. 3A illustrates a checkout user interface 300 of a website as described herein for completing a checkout process. The checkout user interface 300 of FIG. 3A corresponds to the configuration user interface 200 of FIGS. 2A-2B. Aspects of the checkout user interface 300 can be the same as or similar to aspects of the configuration user interface 200.

The checkout user interface 300 can include a header portion 303. The header portion 303 can include a variety of information. For example, in the illustrated embodiment, the header portion 303 includes text “MY SHOPPING CART” that identifies the page which the user is viewing, along with a phone number for questions and a hyperlink to the “CHECKOUT FAQ.” The header portion 303 also can include an indication that the user is signed in to an account. This can, for example, allow a user on a public user device to identify whether they are signed in to another user's account. The header portion 303 can also include textual reminders to a user, such as to select “SEASONAL SHIPPING” in order to get an order by a certain holiday date. The header portion 303 can also include one or more means for continuing to shop or to save the shopping cart.

A virtual bundle image 305 displays an indication that the product in the cart is a virtual bundle. In some embodiments, the virtual bundle image 305 can be a generic image that is displayed regardless of the contents of the virtual bundle. In other embodiments, the virtual bundle image 305 can include images of the products included in the virtual bundle. For example, if the virtual bundle includes a beach towel and a swimsuit, the virtual bundle image 305 can include an image of a swimsuit and an image of a beach towel. In some such embodiments, the virtual bundle image 305 can include images of the specific products selected, or representative images of a beach towel and a swimsuit that are used for any virtual bundle including these categories of products. In some embodiments, where the user has entered the virtual bundle configuration through the social network 125, the virtual bundle image can be the same image as the user selected on the social network.

A virtual bundle name 310 identifies a name of the virtual bundle that has been configured. A bundle promotional savings 315 indicates a promotional message relating to a promotion that is included as part of the virtual bundle. The promotional message can, for example, indicate how much money was saved by bundling the products. A virtual bundle products section 320 includes a listing of the products included within the virtual bundle. Each product included within the virtual bundle includes a product image 325A-325N and a product details section 330A-330N. Each product included within the products section 320 can also include text indicating, for example, the quantity of items included, a shipping method selected, an anticipated delivery date, or the like. The product details sections 330A-330N can include, for example, text about the product or messages specific to a particular product. Examples of messages specific to a product include, but are not limited to, a warranty offering, a seasonal shipping message, a return policy message, or the like. An additional promotional offering 335 is included, according to some embodiments. The additional promotional offering 335 can, for example, be a gift card that is included as an incentive for bundling related products.

The checkout user interface 300 includes a standalone product 340. The standalone product 340 can be any product the user has selected for purchase that is not configured to be a part of a virtual bundle. The standalone product 340 can include a button 345. The button 345 can allow a user to click to configure the standalone product 340 as a part of a virtual bundle. Accordingly, the button 345 can be configured to be displayed on the checkout user interface 300 when the standalone product is a virtual bundle compatible product. Similar to the product section 320 described above, the standalone product 340 can include text indicating, for example, the quantity of items included, a shipping method selected, an anticipated delivery date, or the like.

The checkout user interface 300 includes additional checkout options 350 where the user can identify the purchase as a gift, apply a coupon code, or the like. A purchase summary section 355 can include a summary of the products currently in the cart. Examples of information that can be in the summary section 355 include, but are not limited to, a subtotal, a discount total, an estimated shipping cost, a grand total, or the like.

FIG. 3B illustrates another checkout user interface 300 corresponding to the configuration user interface 200 of FIGS. 2C-2E of a website described herein. Aspects of the checkout user interface 300 can be the same as or similar to aspects of the configuration user interface 200. For simplicity of this specification, aspects of FIGS. 2C-2E previously described will not be discussed in additional detail.

In FIG. 3B, the user is presented with the checkout user interface 300 that includes the clothing virtual bundle which was configured in FIGS. 2C-2E above. The checkout user interface 300 is illustrated with the virtual bundle image 305 being the same as the shirt image that was shown in FIGS. 2C-2E. In some embodiments, the virtual bundle image 305 can include an image of the anchor product and an image of the accessory product. In other embodiments, the virtual bundle image can be an image of, for example, a model or other spokesperson wearing the items included in the clothing bundle. The virtual bundle name 310 includes the name of the virtual bundle as included in the virtual bundle details section 215 of FIGS. 2C-2E. The virtual bundle products section 320 is populated with the images of Shirt B and Tie C as included in the configuration user interface 200 of FIGS. 2C-2E.

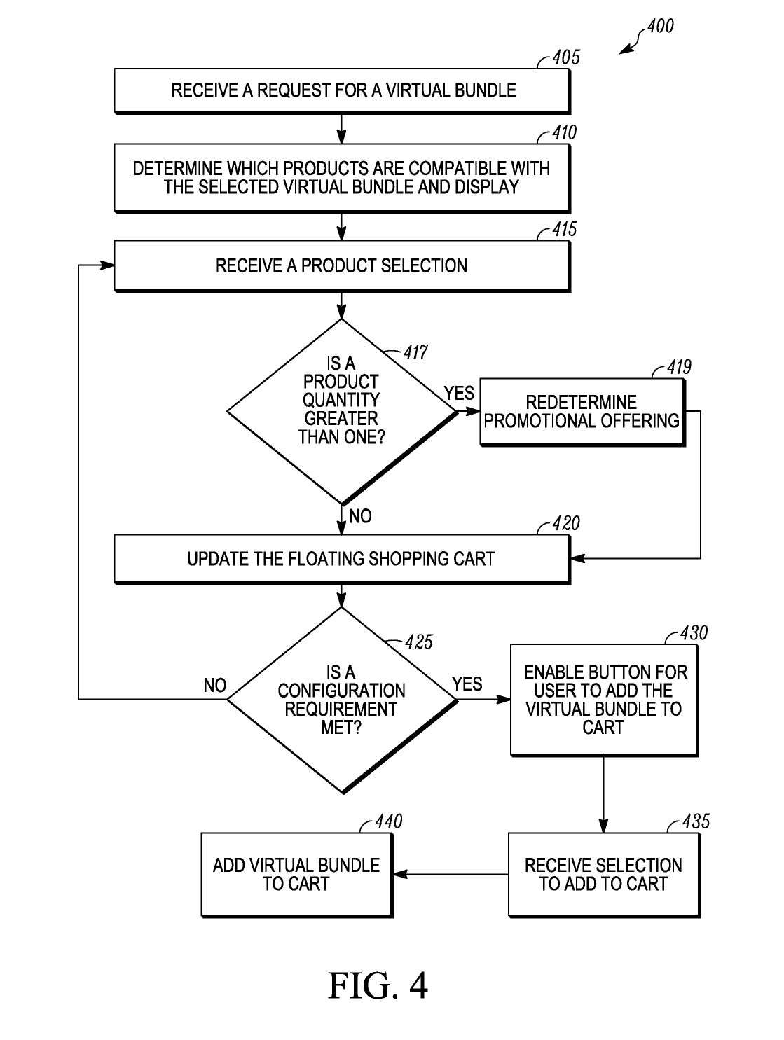

FIG. 4 illustrates a method 400 to provide the configuration user interface 200 for a virtual bundle to a website customer. The method 400 generally includes receiving a user request at the server 105 and providing a configuration user interface 200 and a checkout user interface 300.

The method 400 begins at 405 when the server 105 receives a request for a virtual bundle. The server 105 determines which products can be included in the requested virtual bundle and displays the configuration user interface 200 at 410. The configuration user interface 200 is displayed on the user device 115 including a plurality of products that the user can select from to configure a customized virtual bundle of products for purchase. The server 105 provides an anchor product list (e.g., when the anchor product is selectable) or provides an anchor product and at least one accessory product list. In some embodiments, more than one accessory product list are displayed. When more than one accessory product list is displayed, one or more of the accessory products can be optionally included in the virtual bundle.

At 415, the server 105 receives a selection for a product (either anchor product or accessory product) to be included within the virtual bundle. At 417, the server 105 determines whether a product quantity greater than one was selected. If the product quantity selected was greater than one, the server 105 redetermines a promotional offering based on the products at 419. Redetermining the promotional offer can include identifying which of a plurality of available promotional offers is a “best promotional offer.” A “best promotional offer,” can, for example, be a promotional offer that provides a user with a maximum discount. If the product quantity selected was equal to one, the method 400 continues to 420 without redetermining the promotional offering.

At 420, the server 105 updates the floating shopping cart 220. Updating the floating shopping cart generally includes updating the price 230 and one of the product images 225A-225N. Updating the floating shopping cart 420 can also include updating the promotional offering as redetermined at 417.

At 425, the server 105 determines whether the virtual bundle meets a configuration requirement. For example, in some virtual bundles, this will include determining whether an anchor product and an accessory product have been selected. In other virtual bundles, this can include an anchor product and more than one accessory product. The configuration requirement can generally be based on the virtual bundle selected (e.g., a virtual bundle for a camera, camera lens, and camera case may require three product selections to meet the product requirement).

If the configuration requirement is met at 425, the server 105 enables the button 235 so that a user can add the virtual bundle to her cart at 430. If, however, the configuration requirement is not met at 425, the method 400 returns to 415 so that the user continues updating the product selections to be included with the virtual bundle.

At 435, once the product requirement has been met, the server 105 receives a selection to add the virtual bundle to the user's cart and, at 440, the server 105 adds the virtual bundle to the user's cart.

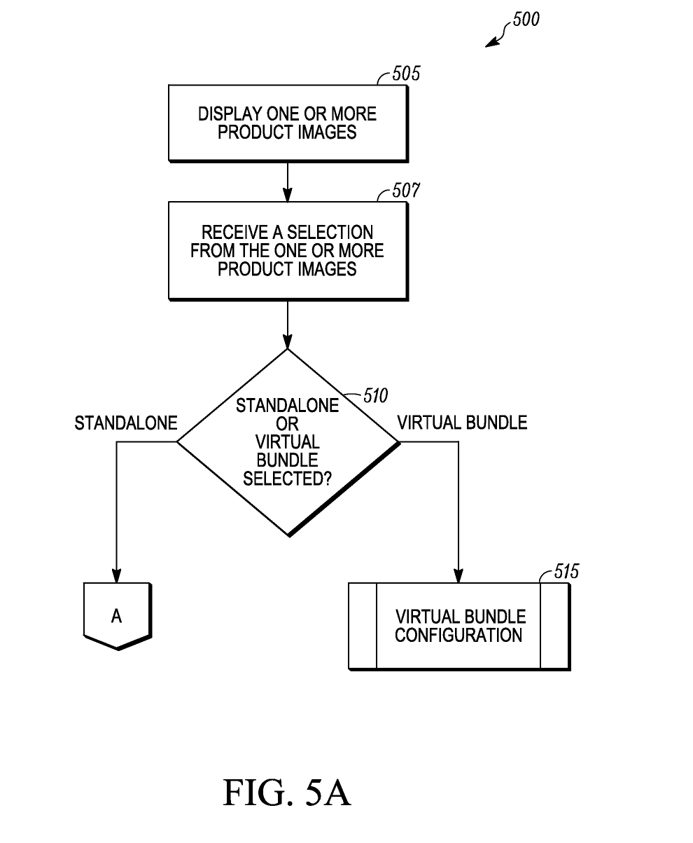

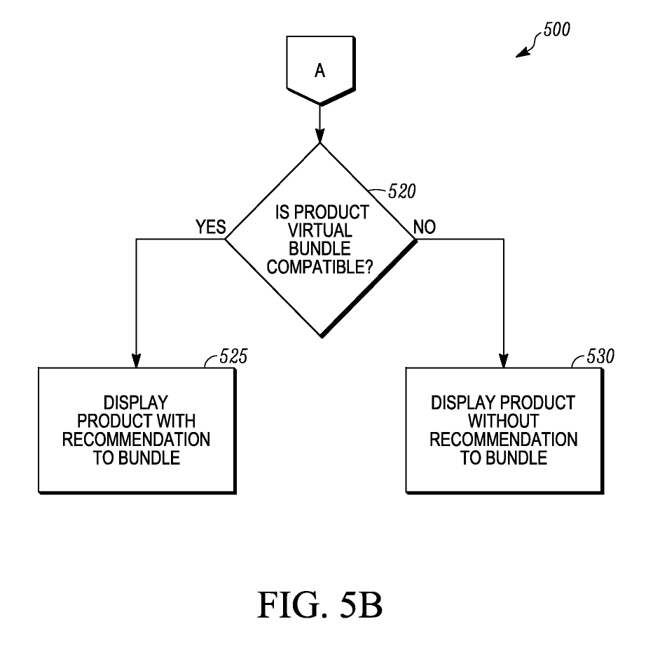

FIGS. 5A-5B illustrate a method 500 for determining whether to display the configuration user interface 200 (FIG. 2). The method 500 generally includes determining whether a user has selected a standalone product or a virtual bundle.

The method 500 begins at 505. At 505, the server 105 displays one or more product images on the user interface 115 (FIG. 1). At 507, the server 105 receives a selection of a product from the one or more product images displayed on the user interface 115.

At 510, the server 105 determines whether a customer has selected a virtual bundle or a standalone product. When the user has selected a virtual bundle, the method 500 continues to 515 and the user is directed to the configuration user interface 200 for configuring the virtual bundle (e.g., the method 400 of FIG. 4). If the customer did not select a virtual bundle (e.g., a standalone product was selected), the server 105 determines whether the standalone product selected is a virtual bundle compatible product at 520. If the standalone product is a virtual bundle compatible product, information related to the selected standalone product is displayed on the user interface 115 at 525 along with a recommendation that the user can configure a virtual bundle including the product and receive a promotion. The recommendation can, for example, be in the form of a hyperlink that when selected directs a user to the configuration user interface 200. At 530, if the selected product is not a virtual bundle compatible product, the server 105 can display the standalone product on the user interface 115 without a recommendation to configure a virtual bundle including the standalone product. The process of purchasing a standalone product is according to principles known in the art for purchasing a product from a retail website.

FIG. 6 is a schematic diagram of an architecture for a computer device 600. The computer device 600 and any of the individual components thereof can be used for any of the operations described in accordance with any of the computer-implemented methods described herein.

The computer device 600 generally includes a processor 610, memory 620, a network input/output (I/O) 625, storage 630, and an interconnect 650. The computer device 600 can optionally include a user I/O 615, according to some embodiments. The computer device 600 can be in communication with one or more additional computer devices 600 through a network 640.

The computer device 600 is generally representative of hardware aspects of a variety of user devices 601 and a server device 635. The illustrated user devices 601 are examples and are not intended to be limiting. Examples of the user devices 601 include, but are not limited to, a desktop computer 602, a cellular/mobile phone 603, a tablet device 604, and a laptop computer 605. It is to be appreciated that the user devices 601 can include other devices such as, but not limited to, a personal digital assistant (PDA), a video game console, a television, or the like. In some embodiments, the user devices 601 can alternatively be referred to as client devices 601. In such embodiments, the client devices 601 can be in communication with the server device 635 through the network 640. One or more of the client devices 601 can be in communication with another of the client devices 601 through the network 640 in some embodiments.

The processor 610 can retrieve and execute programming instructions stored in the memory 620 and/or the storage 630. The processor 610 can also store and retrieve application data residing in the memory 620. The interconnect 650 is used to transmit programming instructions and/or application data between the processor 610, the user I/O 615, the memory 620, the storage 630, and the network I/O 640. The interconnect 650 can, for example, be one or more busses or the like. The processor 610 can be a single processor, multiple processors, or a single processor having multiple processing cores. In some embodiments, the processor 610 can be a single-threaded processor. In some embodiments, the processor 610 can be a multi-threaded processor.

The user I/O 615 can include a display 616 and/or an input 617, according to some embodiments. It is to be appreciated that the user I/O 615 can be one or more devices connected in communication with the computer device 600 that are physically separate from the computer device 600. For example, the display 616 and input 617 for the desktop computer 602 can be connected in communication but be physically separate from the computer device 600. In some embodiments, the display 616 and input 617 can be physically included with the computer device 600 for the desktop computer 602. In some embodiments, the user I/O 615 can physically be part of the user device 601. For example, the cellular/mobile phone 603, the tablet device 604, and the laptop 605 include the display 616 and input 617 that are part of the computer device 600. The server device 635 generally may not include the user I/O 615. In some embodiments, the server device 635 can be connected to the display 616 and input 617.

The display 616 can include any of a variety of display devices suitable for displaying information to the user. Examples of devices suitable for the display 616 include, but are not limited to, a cathode ray tube (CRT) monitor, a liquid crystal display (LCD) monitor, a light emitting diode (LED) monitor, or the like.

The input 617 can include any of a variety of input devices or means suitable for receiving an input from the user. Examples of devices suitable for the input 617 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 617 can be included for the user devices 601. In some embodiments the input 617 can be integrated with the display 616 such that both input and output are performed by the display 616.

The memory 620 is generally included to be representative of a random access memory such as, but not limited to, Static Random Access Memory (SRAM), Dynamic Random Access Memory (DRAM), or Flash. In some embodiments, the memory 620 can be a volatile memory. In some embodiments, the memory 620 can be a non-volatile memory. In some embodiments, at least a portion of the memory can be virtual memory.

The storage 630 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 630 is a computer readable medium. In some embodiments, the storage 630 can include storage that is external to the computer device 600, such as in a cloud.

The network I/O 625 is configured to transmit data via a network 640. The network 640 may alternatively be referred to as the communications network 640. Examples of the network 640 include, but are not limited to, a local area network (LAN), a wide area network (WAN), the Internet, or the like. In some embodiments, the network I/O 625 can transmit data via the network 640 through a wireless connection using WiFi, Bluetooth, or other similar wireless communication protocols. In some embodiments, the computer device 600 can transmit data via the network 640 through a cellular, 3G, 4G, or other wireless protocol. In some embodiments, the network I/O 625 can transmit data via a wire line, an optical fiber cable, or the like. It is to be appreciated that the network I/O 625 can communicate through the network 640 through suitable combinations of the preceding wired and wireless communication methods.

The server device 635 is generally representative of a computer device 600 that can, for example, respond to requests received via the network 640 to provide, for example, data for rendering a website on the user devices 601. The server 635 can be representative of a data server, an application server, an Internet server, or the like.

Aspects described herein can be embodied as a system, method, or computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are examples only, with the true scope and spirit of the disclosure being indicated by the claims that follow.

What is claimed is:

1. A computer-implemented method of presenting products to a consumer for purchase via a graphical user interface (GUI) on a display of a user device of the consumer, comprising:
via a website that is accessible by the consumer and that is made available by one or more servers:
receiving a request from the user device to configure a virtual bundle;
displaying, on the display of the user device, a product listing, the product listing comprising:
an anchor product listing and at least one accessory product listing;
displaying, on the display of the user device, a promotional offering associated with the virtual bundle, the promotional offering based on one of the anchor product listing and the at least one accessory product listing;
receiving a product selection from a plurality of product images;
adding the product selection to the virtual bundle; and
updating a floating shopping cart based on the product selection.

2. The computer-implemented method according to claim 1, wherein displaying the product listing further comprises:
determining one or more virtual bundle compatible products for the anchor product listing and one or more virtual bundle compatible products for the at least one accessory product listing.

3. The computer-implemented method according to claim 1, wherein displaying the product listing further comprises:
identifying the at least one accessory product listing based on the anchor product listing such that the at least one accessory product listing is compatible with the anchor product listing.

4. The computer-implemented method according to claim 1, further comprising:
determining whether a configuration requirement has been met; and
enabling a checkout button when the configuration requirement has been met.

5. The computer-implemented method according to claim 4, wherein the configuration requirement includes requiring at least one anchor product from the anchor product listing and at least one accessory product from the at least one accessory product listing to be added to the virtual bundle.

6. The computer-implemented method according to claim 1, further comprising:
receiving a virtual bundle image from a social network when the consumer is forwarded to the website from the social network; and
displaying on the display of the user device the virtual bundle image from the social network.

7. The computer-implemented method according to claim 1, wherein receiving a product selection comprises:
receiving a quantity in the product selection that is greater than one; and
redetermining a promotional offering, wherein the redetermining comprises identifying a best promotional offer from those available.

8. A system, comprising:
a server in communication with a network, the server executing instructions for a graphical user interface (GUI) and displaying the GUI on a display of a user device for grouping related products for purchase, the GUI comprising:
a product grouping displayed on the display, the product grouping comprising:
one or more products identified as eligible for being grouped with one or more other products for purchase;
a base product grouping, wherein the base product grouping includes at least one base product;
at least one accessory product grouping, wherein each of the at least one accessory product groupings includes at least one accessory product determined based on the base product grouping; and
a shopping cart displayed on the display, wherein the shopping cart includes a scrolling means so that the shopping cart remains displayed on the display when a user scrolls to another portion of the GUI,
wherein the at least one base product is selectable to configure in a product package and the at least one accessory product is selectable to configure in the product package.

9. The system according to claim 8, further comprising:
a promotional offer displayed on the display, wherein the promotional offer is associated with the product package.

10. The system according to claim 8, wherein the shopping cart includes two or more of a product image for each product of the product package, a price of the product package, a checkout button, and notice information.

11. The system according to claim 8, wherein a product package image is displayed on the display.

12. The system according to claim 11, wherein the product package image comprises a plurality of product images associated with the product package.

13. The system according to claim 11, wherein the product package image comprises a plurality of product images and is an image received from a social network.

14. The system according to claim 8, wherein the product package is configurable to include one or more of a plurality of base products and a plurality of accessory products.

15. The system according to claim 8, wherein the product package comprises the at least one base product and a plurality of accessory products.

16. The system according to claim 8, wherein the base product grouping and/or the at least one accessory product grouping include one of a sorting button and a filtering button, wherein the sorting button and the filtering button include one or more options to modify display of the base product grouping and/or the at least one accessory product grouping, and
wherein the sorting button and the filtering button are configured to modify one or more of a display order for products within the base product grouping and/or the at least one accessory product grouping and which products are displayed within the base product grouping and/or the at least one accessory product grouping.

17. An Internet website interface, comprising:
one or more servers connectable to the Internet and configured to provide a website interface for configuring a bundle of products for purchase, the website interface is viewable on the Internet and displays a plurality of product images arranged in a product listing, each product image is of a product that is a bundle compatible product, the product listing includes a primary product listing and one or more secondary product listings, wherein the one or more secondary product listings are compatible with the primary product listing, the website interface displaying a floating shopping cart displaying two or more of a cart product image, a bundle price, a checkout button, and notice information, wherein one of the primary product listing and the one or more secondary product listing include one of a filter button and a sort button.

18. The Internet website interface according to claim 17, further comprising a promotional offer associated with the bundle and displayed on the website interface.

19. The Internet website interface according to claim 17, wherein the product images are selectable for configuring the bundle with a primary product from the primary product listing and one or more secondary products from the one or more secondary product listings.

20. The Internet website interface according to claim 17, further comprising:
a checkout user interface displaying the bundle in a configured state, wherein the bundle in the configured state is modifiable from the checkout user interface, and wherein in the configured state a primary product from the primary product listing and one or more secondary products from the one or more secondary product listings are selected for the bundle.
